(19) United States
(12) Patent Application Publication
(10) Pub. No.: US 2018/0324082 A1
(43) Pub. Date: Nov. 8, 2018

(54) WEIGHT SETTING USING INVERSE OPTIMIZATION

(71) Applicants: Fang Hao, Morganville, NJ (US); Murali Kodialam, Marlboro, NJ (US); Tirunell V. Lakshman, Marlboro, NJ (US)

(72) Inventors: Fang Hao, Morganville, NJ (US); Murali Kodialam, Marlboro, NJ (US); Tirunell V. Lakshman, Marlboro, NJ (US)

(21) Appl. No.: 15/587,649

(22) Filed: May 5, 2017

(51) Int. Cl. H04L 12/721; H04L 12/733; H04W 40/02

(52) U.S. Cl. CPC H04L 45/123; H04L 45/14; H04W 40/02; H04L 45/126

(57) ABSTRACT

The present disclosure generally discloses improvements in computer performance for supporting use of shortest path routing in a communication network. The shortest path routing capability may be configured to support setting of link weights for use in shortest path routing. The shortest path routing capability may be configured to support setting of link weights for use in shortest path routing based on inverse optimization. The shortest path routing capability may be configured to support setting of link weights for use in shortest path routing based on distance between traffic matrices (e.g., distance between a requested traffic matrix and a routed traffic matrix). The shortest path routing capability may be configured to determine, based on the distance between a requested traffic matrix and a routed traffic matrix, whether to accept or reject a set of link weights for a network.

### TECHNICAL FIELD

The present disclosure relates generally to communication networks and, more particularly but not exclusively, to improvements in computer performance for supporting use of shortest path routing in communication networks.

### BACKGROUND

Communication networks support transport of traffic via nodes and communication links. Many types of communication networks support transport of traffic based on routing protocols. Many such routing protocols use shortest path routing to support transport of traffic between ingress nodes and egress nodes of the communication networks. Many such routing protocols that rely on shortest path routing are configured to compute shortest paths based on link weights associated with the communication links of the communication network. In many such communication networks, a basic problem associated with use of routing protocols that rely on shortest path routing is determination of the links weights for the communication links of the communication network.

### SUMMARY

The present disclosure generally discloses improvements in computer performance for supporting use of shortest path routing in a communication network.

In at least some embodiments, an apparatus is provided. The apparatus includes a processor and a memory communicatively connected to the processor. The processor is configured to receive a requested traffic matrix indicative of traffic to be routed through a network including a set of nodes and a set of links, a set of link weights associated with the respective links, and a performance metric. The processor is configured to determine, based on the requested traffic matrix and the set of link weights, a routed traffic matrix indicative of routing of the traffic of the requested traffic matrix in the network using the set of link weights. The processor is configured to determine, based on the performance metric, a distance between the requested traffic matrix and the routed traffic matrix. The processor is configured to determine, based on the distance between the requested traffic matrix and the routed traffic matrix, whether to accept or reject the set of link weights for the network.

In at least some embodiments, a method is provided. The method includes receiving a requested traffic matrix indicative of traffic to be routed through a network including a set of nodes and a set of links, a set of link weights associated with the respective links, and a performance metric. The method includes determining, based on the requested traffic matrix and the set of link weights, a routed traffic matrix indicative of routing of the traffic of the requested traffic matrix in the network using the set of link weights. The method includes determining, based on the performance metric, a distance between the requested traffic matrix and the routed traffic matrix. The method includes determining, based on the distance between the requested traffic matrix and the routed traffic matrix, whether to accept or reject the set of link weights for the network.

In at least some embodiments, a non-transitory computer-readable storage medium stores instructions which, when executed by a computer, cause the computer to perform a method. The method includes receiving a requested traffic matrix indicative of traffic to be routed through a network including a set of nodes and a set of links, a set of link weights associated with the respective links, and a performance metric. The method includes determining, based on the requested traffic matrix and the set of link weights, a routed traffic matrix indicative of routing of the traffic of the requested traffic matrix in the network using the set of link weights. The method includes determining, based on the performance metric, a distance between the requested traffic matrix and the routed traffic matrix. The method includes determining, based on the distance between the requested traffic matrix and the routed traffic matrix, whether to accept or reject the set of link weights for the network.

### BRIEF DESCRIPTION OF THE DRAWINGS

The teachings herein can be readily understood by considering the following detailed description in conjunction with the accompanying drawings, in which:

FIG. 1 depicts an example communication system configured to support use of shortest path routing in a communication network;

FIG. 2 depicts an embodiment of a method for supporting shortest path routing within a communication network;

FIG. 3 depicts an embodiment of a method for determining link weights for a set of links of a communication network for use in supporting shortest path routing within the communication network;

FIG. 4 depicts an embodiment of a method for determining link weights for a set of links of a communication network for use in supporting shortest path routing within the communication network;

FIG. 5 depicts an example of pseudocode for an example process for determining a distance between traffic vectors for use in determining link weights for a set of links of a communication network;

FIG. 6 depicts an example of pseudocode for an example process for evaluating modifications of link weights for use in determining link weights for a set of links of a communication network;

FIG. 7 depicts an example of pseudocode for an example process for determining a fraction of a commodity carried on a link for use in determining distance between traffic vectors for use in determining link weights for a set of links of a communication network;

FIG. 8 depicts an example of pseudocode for an example process for determining a distance between traffic vectors for use in determining link weights for a set of links of a communication network; and

FIG. 9 depicts a high-level block diagram of a computer suitable for use in performing various functions presented herein.

To facilitate understanding, identical reference numerals have been used, where possible, to designate identical elements that are common to the figures.

### DETAILED DESCRIPTION

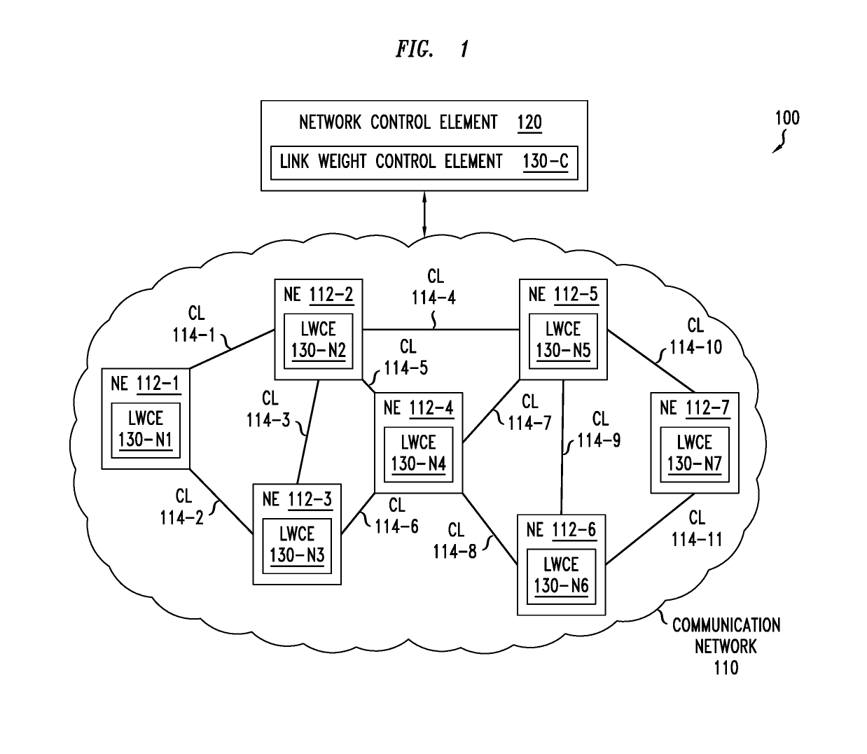

The present disclosure generally discloses improvements in computer performance for supporting use of shortest path routing in a communication network. The shortest path routing capability may be configured to support setting of link weights for use in shortest path routing. The shortest path routing capability may be configured to support setting of link weights for use in shortest path routing based on inverse optimization. The shortest path routing capability may be configured to support setting of link weights for use in shortest path routing by receiving a requested traffic matrix and determining a set of link weights that achieves the requested traffic matrix or that achieves an actual traffic matrix that is relatively close to the requested traffic matrix (e.g., within or at least approaching or tending to approach a threshold level of “closeness”). The closeness of the actual traffic matrix to the requested traffic matrix may be based on a distance measure indicative of a distance between the requested traffic matrix and the actual traffic matrix which may be achieved by the determined set of link weights. The shortest path routing capability may be configured to support setting of link weights for use in shortest path routing based on successive refinement of an initial set of link weights to arrive at a final set of link weights that achieves the requested traffic matrix or an actual traffic matrix that is relatively close to the requested traffic matrix. It will be appreciated that these and various other embodiments and advantages or potential advantages of the shortest path routing capability may be further understood by way of reference to the example communication system of FIG. 1.

FIG. 1 depicts an example communication system configured to support use of shortest path routing in a communication network.

The communication system 100 includes a communication network (CN) 110 and a network control element (NCE) 120 that is communicatively connected to the CN 110.

The CN 110 may be any communication network configured to support transport of traffic using shortest path routing. The CN 110 includes a set of network elements (NEs), or nodes, 112-1-112-7 (collectively, NEs 112) and a set of communication links (CLs), or links, 114-1-114-11 (collectively, CLs 114).

The NEs 112 are configured to support communication of traffic within CN 110. The NEs 112 may be configured to receive traffic via CLs 114 and transmit traffic via CLs 114 based on various types of traffic routing protocols. The NEs 112 may be configured to operate as source nodes for traffic of CN 110, intermediate nodes for traffic of CN 110, destination nodes for traffic of CN 110, or combinations thereof. The NEs 112 may include any suitable types of network elements of a communication network (which may depend on the communication network type of CN 110), such as routers, switches, or the like.

The CLs 114 are configured to support communication of traffic within CN 110. The CLs 114 may be configured to transport traffic in various formats based on various types of traffic routing protocols. The CLs 114 may include any suitable types of communication links of a communication network (which may depend on the communication network type of CN 110), such as wired links, wireless links, or the like.

The CN 110, as indicated above, may be configured to support communication of traffic based on various types of traffic routing protocols. The traffic routing protocols may be based on shortest path routing based on link weights of the CLs 114. For example, the traffic routing protocols may include Interior Gateway Protocols (IGPs) such as the Open Shortest Path First (OSPF) protocol and the Intermediate System to Intermediate System (IS-IS) protocol, Exterior Gateway Protocols (EGPs) such as the Border Gateway Protocol (BGP), or the like, as well as various combinations thereof. The traffic routing protocols may depend on the communication network type of CN 110.

The NCE 120 may be configured to provide network control functions for CN 110. The NCE 120 may be any suitable type of control element for a communication network (which may depend on the communication network type of CN 110), such as an element management system (EMS), a network management system (NMS), a path computation element (PCE), a Software Defined Networking (SDN) controller, or the like.

The communication system 100 may be configured to support control of link weights for the CLs 114 of CN 110, which may include determination of link weights for the CLs 114 of the CN 110, use of the link weights for the CLs 114 of the CN 110 to support transport of traffic via the CN 110, or the like, as well as various combinations thereof. The control of the link weights for the CLs 114 of the CN 110 may be supported using a set of link weight control elements (LWCEs) 130, which includes a set of LWCEs 130-N1-130-N7 on the NEs 112-1-112-7, respectively, and, optionally, based on a LWCE 130-C on the NCE 120. The determination of link weights for the CLs 114 of the CN 110 may be performed by one or more of the LWCEs 130 in a centralized or distributed manner and then communicated to the NEs 112 (e.g., based on link state advertisements exchanged between NEs 112 when the link weights for the CLs 114 are determined by one of the LWCEs 130-N, based on targeted link state information messages provided to the NEs 112 when the link weights for the CLs 114 are determined by one of the LWCEs 130-N or by the LWCE 130-C on the NCE 120, or the like). The use of the link weights for the CLs 114 of the CN 110 to support transport of traffic via the CN 110 is performed in a distributed manner by the NEs 112 based on the link weights for the CLs 114 that are provided to the NEs 112 when the link weights for the CLs 114 are determined. The communication system 100 may be configured to support various other functions in order to support transport of traffic via the CN 110 based on shortest path routing using link weights.

It will be appreciated that, although CN 110 is primarily presented herein as having specific numbers, types, and arrangements of NEs 112 and CLs 114, CN 110 may have various other numbers, types, and arrangements of NEs 112 and/or CLs 114.

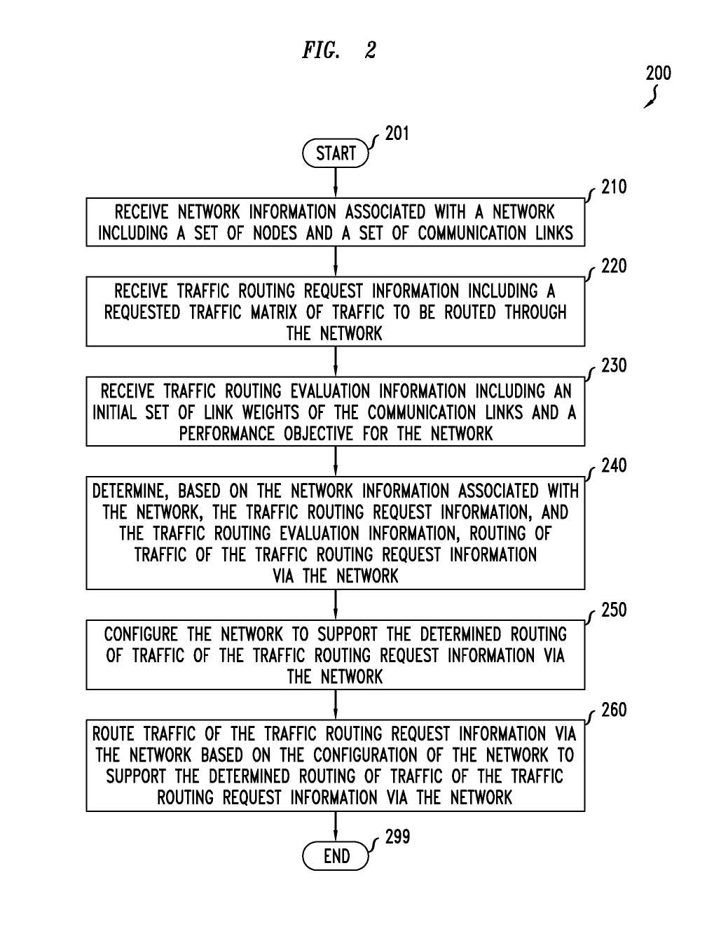

FIG. 2 depicts an embodiment of a method for supporting shortest path routing within a communication network. It will be appreciated that functions of method 200, although presented in FIG. 2 as being performed serially, may be performed contemporaneously or in a different order than as presented in FIG. 2.

At block 201, method 200 begins.

At block 210, network information associated with the network is received. The network information associated with the network may include network topology information for the network (e.g., a list of nodes of the network, a list of communication links of the network, a description of connectivity between the nodes of the network based on communication links of the network, or the like, as well as various combinations thereof). The network information associated with the network may include other types of information describing the network or otherwise associated with the network.

At block 220, traffic routing request information for the network is received. The traffic routing request information may include a requested traffic matrix. The requested traffic matrix may indicated, for each pair of source node and destination node in the network, an indication of an amount of traffic to be routed between the source node and the destination node, respectively. For example, where the network includes n nodes, the requested traffic matrix may be an n×n matrix. The requested traffic matrix also may be referred to herein as a requested traffic vector, a demand matrix, or a demand vector. The traffic routing request information may include other types of information describing or otherwise associated with a request for traffic to be routed within the network. The traffic routing request information may be received responsive to an event (e.g., identification of a request or set of requests for traffic to be routed through the network). The traffic routing request information may be received responsive to a request for the traffic routing request information (e.g., the traffic routing request information is requested based on an indication of a request or requests to route traffic via the network), responsive to an event (e.g., identification of a request or set of requests for traffic to be routed through the network), or the like.

At block 230, traffic routing evaluation information for the network is received. The traffic routing evaluation information may include an initial set of link weights of the communication links of the network (e.g., the actual link weights of the communication links which may or may not need to be modified to support the requested traffic matrix, suggested link weights for the communication links which may or may not need to be modified to support the requested traffic matrix, or the like), a performance objective adapted for use in evaluating routing of the traffic of the requested traffic matrix within the network (e.g., a maximum link utilization or other suitable type of performance objective), or the like, as well as various combinations thereof. The traffic routing evaluation information may include other types of information suitable for use in evaluating routing of traffic within the network. The traffic routing evaluation information may be received responsive to a request for the traffic routing evaluation information (e.g., the traffic routing evaluation information is requested based on receipt of the traffic routing request information or responsive to an event associated with receipt of the traffic routing request information), responsive to an event (e.g., identification of a request or set of requests for traffic to be routed through the network), or the like.

At block 240, routing of traffic of the traffic routing request information via the network is determined based on the network information associated with the network, the traffic routing request information, and the traffic routing evaluation information.

The determination of routing of the traffic of the traffic routing request information via the network may include determining routing of traffic of the requested traffic matrix via the network based on the network information associated with the network (e.g., the network topology information) and the traffic routing evaluation information (e.g., the initial set of link weights and the performance metric).

The determination of the routing of traffic of the requested traffic matrix via the network based on the traffic routing evaluation information may be based on inverse optimization.

The determination of the routing of traffic of the requested traffic matrix via the network based on the traffic routing evaluation information may include determining a set of link weights that supports the requested traffic matrix or that tends to support the requested traffic matrix by supporting an actual traffic matrix that is relatively close to the requested traffic matrix (e.g., within or at least approaching a threshold level of “closeness”). The closeness of the actual traffic matrix to the requested traffic matrix may be based on a measure of distance between the actual traffic matrix and the requested traffic matrix for a given set of link weights of the communication links. The measure of distance between the actual traffic matrix and the requested traffic matrix may be based on the performance objective adapted for use in evaluating routing of the traffic of the requested traffic matrix within the network (e.g., maximum link utilization or other suitable performance objectives). The measure of distance between the actual traffic matrix and the requested traffic matrix may be a Euclidean distance or other suitable type of distance.

The determination of the routing of traffic of the requested traffic matrix via the network based on the traffic routing evaluation information, as noted above, may include determining a set of link weights that supports the requested traffic matrix or that tends to support the requested traffic matrix by supporting an actual traffic matrix that is relatively close to the requested traffic matrix (e.g., within or at least approaching a threshold level of “closeness”). The determined set of link weights may be determined by transitioning from the initial set of link weights of the communication links to a final set of link weights of the communication network that either supports the requested traffic matrix or that tends to support the requested traffic matrix by supporting an actual traffic matrix that is relatively close to the requested traffic matrix, where the closeness of an actual traffic matrix to the requested traffic matrix may be determined for each successive modification of the set of link weights in order to determine the final set of link weights of the communication network that either supports the requested traffic matrix or that tends to support the requested traffic matrix by supporting an actual traffic matrix that is relatively close to the requested traffic matrix. The modification of the link weights for determining the final set of link weights of the communication network that either supports the requested traffic matrix or tends to support the requested traffic matrix may be performed in various ways (e.g., using a predetermined threshold for the number of modifications which may be made to the set of link weights before the final set of link weights is selected, only accepting a modification to the set of link weights based on a determination that the modification to the set of link weights improves the closeness of the actual traffic matrix to the requested traffic matrix or improves the closeness of the actual traffic matrix to the requested traffic matrix by a threshold amount, or the like, as well as various combinations thereof).

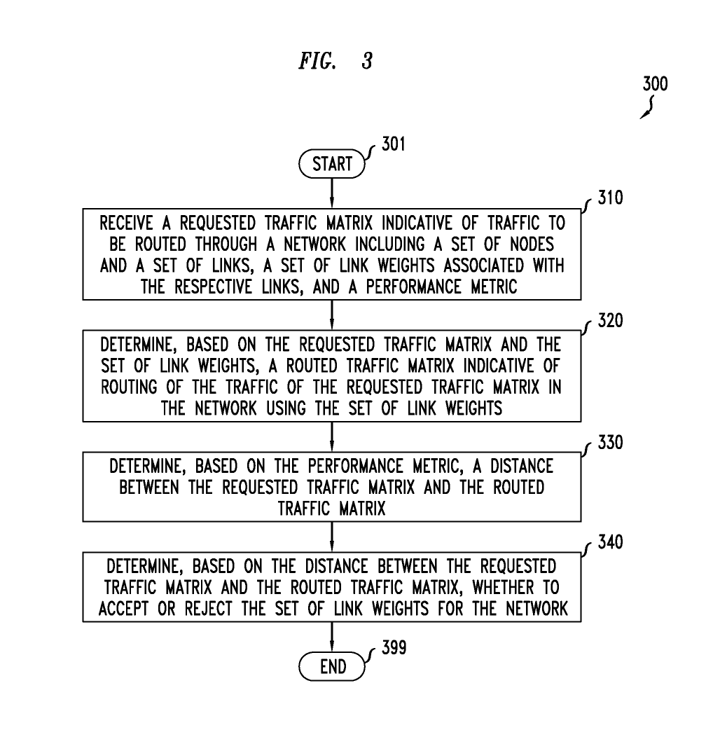

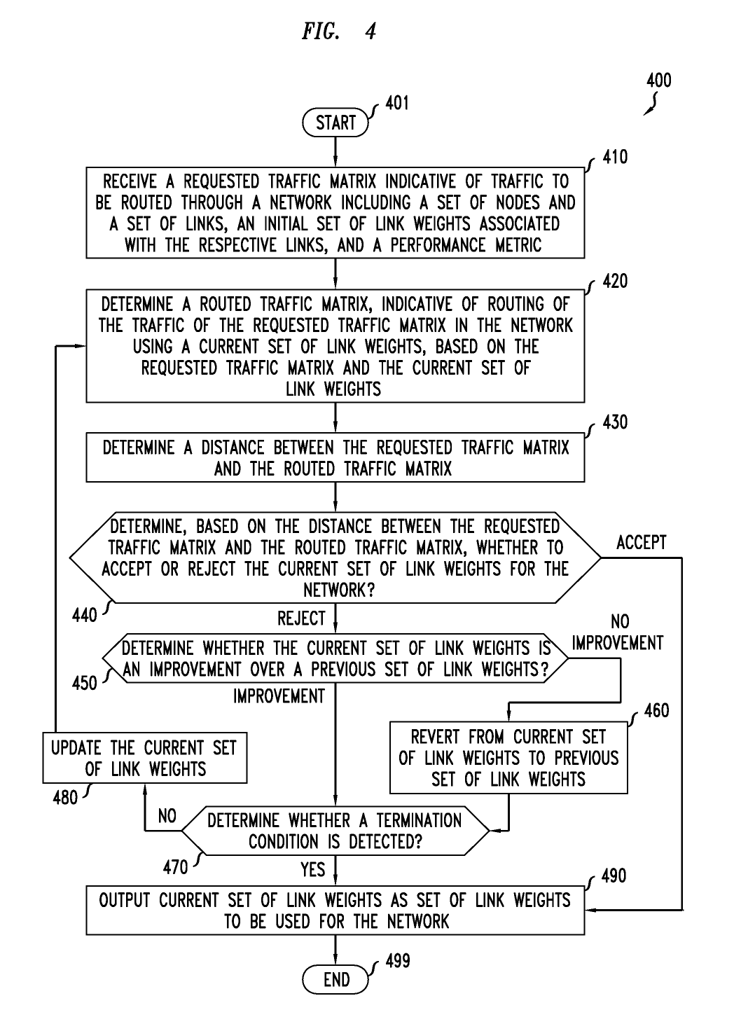

It is noted that example processes for determining a set of link weights that supports the requested traffic matrix or that tends to support the requested traffic matrix by supporting an actual traffic matrix that is relatively close to the requested traffic matrix are presented with respect to FIG. 3 and FIG. 4

At block 250, the network is configured to support the determined routing of traffic of the traffic routing request information. The determined routing of traffic of the traffic routing request information may support routing of the requested traffic matrix or an actual traffic matrix that is as close as possible to the requested traffic matrix while also satisfying a performance objective. The network may be configured to support the determined routing of traffic of the traffic routing request information by configuring the network to use the final set of link weights of the communication links, such that the requested traffic matrix or the actual traffic matrix that is as close as possible to the requested traffic matrix is realized within network. The network may be configured to use the final set of link weights of the communication links by sending link advertisements within the network in order to make the nodes aware of the link weights (e.g., in a distributed arrangement in which the link weights are determined by one or more of the nodes of the network), by sending configuration messages to the nodes of the network to make the nodes aware of the link weights (e.g., in a centralized arrangement in which the link weights are determined by a network control element that is able to configure the nodes to use the link weights), or the like, as well as various combinations thereof.

At block 260, traffic is routed through the network based on the configuration of the network to support the determined routing of traffic of the traffic routing request information. As indicated above, the routing of the traffic through the network based on the configuration of the network to support the determined routing of traffic of the traffic routing request information may or may not result in an actual traffic matrix within the network that this the same as the requested traffic matrix (e.g., the final set of link weights satisfying the performance objective may or may not be able to support the actual traffic request).

At block 299, method 200 ends.

It will be appreciated that method 200 of FIG. 2 may be adapted to perform various other functions presented herein as being supported by a network element or network elements (e.g., NEs 112) and/or a network control element (e.g., NCE 120) to support use of shortest path routing in a communication network.

It will be appreciated that, although method 200 of FIG. 2 is primarily presented as including a determination of routing of a requested traffic matrix via a communication network based on traffic routing evaluation information, the determination of routing of a requested traffic matrix via a communication network based on traffic routing evaluation information may, as indicated above, include a determination of a set of link weights for a set of links of a communication network for use in supporting shortest path routing within the communication network. An example is presented with respect to FIG. 3.

FIG. 3 depicts an embodiment of a method for determining link weights for a set of links of a communication network for use in supporting shortest path routing within the communication network. It will be appreciated that functions of method 300, although presented in FIG. 3 as being performed serially, may be performed contemporaneously or in a different order than as presented in FIG. 3.

At block 301, method 300 begins.

At block 310, a requested traffic matrix indicative of traffic to be routed through a network including a set of nodes and a set of links, a set of link weights associated with the respective links, and a performance metric are received.

At block 320, a routed traffic matrix indicative of routing of the traffic of the requested traffic matrix in the network using the set of link weights is determined based on the requested traffic matrix and the set of link weights.

At block 330, a distance between the requested traffic matrix and the routed traffic matrix is determined.

At block 340, a determination, as to whether to accept or reject the set of link weights for the network, is made based on the distance between the requested traffic matrix and the routed traffic matrix.

At block 399, method 300 ends.

It will be appreciated that method 300 of FIG. 3 may be adapted to perform various other functions presented herein as being supported by a link weight control element (e.g., one or more of the LWCEs 130) for determining link weights for a set of links of a communication network for use in supporting shortest path routing within the communication network.

It will be appreciated that, although method 300 of FIG. 3 is primarily presented as being an acceptance or rejection of the set of weights for the network, method 300 may be adapted to provide an iterative process in which the link weights may be adapted in order to try to iteratively approach a set of link weights that will support the requested traffic matrix or at least a traffic matrix that is relatively close to the requested traffic matrix (e.g., within or at least approaching a threshold level of “closeness”). An example is presented with respect to FIG. 4.

FIG. 4 depicts an embodiment of a method for determining link weights for a set of links of a communication network for use in supporting shortest path routing within the communication network. It will be appreciated that functions of method 400, although presented in FIG. 4 as being performed serially, may be performed contemporaneously or in a different order than as presented in FIG. 4.

At block 401, method 400 begins.

At block 410, a requested traffic matrix indicative of traffic to be routed through a network including a set of nodes and a set of links, an initial set of link weights associated with the respective links, and a performance metric are received. The initial set of link weights may be a previously used set of link weights of the network (e.g., to provide a so-called “hot start” where the new set of link weights to be determined might be the same as or relatively close to the previously used set of link weights), a suggested set of link weights (e.g., a default set of link weights, a set of link weights suggested based on one or more previously used sets of link weights of the network, or the like).

At block 420, a routed traffic matrix indicative of routing of the traffic of the requested traffic matrix in the network using a current set of link weights (e.g., the initial set of link weights in a first pass through method 400 and the most recent updated set of link weights in subsequent passes through method 400) is determined based on the requested traffic matrix and the set of link weights.

At block 430, a distance between the requested traffic matrix and the routed traffic matrix is determined. The distance may be determined as a Euclidean distance or other suitable type of distance.

At block 440, a determination, as to whether to accept or reject the current set of link weights for the network, is made based on the distance between the requested traffic matrix and the routed traffic matrix. The determination as to whether to accept or reject the current set of link weights for the network may be based on a distance threshold (e.g., accept the current set of link weights based on a determination that the distance between the requested and routed traffic matrices satisfies the distance threshold or reject the current set of link weights based on a determination that the distance between the requested and routed traffic matrices fails to satisfy the distance threshold). If a determination is made to reject the current set of link weights for the network, the method 400 proceeds to block 450. If a determination is made to accept the current set of link weights for the network, the method 400 proceeds to block 490.

At block 450, a determination is made as to whether the current set of link weights is an improvement over a previous set of link weights (i.e., the “current” set of link weights in the previous loop through the method 400). This also may be considered to be a determination as to whether the latest update to the set of link weights has improved (or worsened) the set of link weights in terms of identifying a set of link weights that produces the requested traffic matrix. The determination as to whether the latest update to the set of link weights has improved or worsened the set of link weights in terms of identifying a set of link weights that produces the requested traffic matrix may be based on the distance between the requested and routed traffic matrices. It is noted that a decrease in the distance between the requested and routed traffic matrices as compared to the previous set of link weights is indicative that the current set of link weights has produced a routed traffic matrix that is closer to the requested traffic matrix as compared with the previous set of link weights (i.e., that the latest update to of set of link weights has improved the set of link weights) while an increase in the distance between the requested and routed traffic matrices as compared to the previous set of link weights is indicative that the current set of link weights has produced a routed traffic matrix that is farther from the requested traffic matrix as compared with the previous set of link weights (i.e., that the latest update to of set of link weights has worsened the set of link weights). If a determination is made that the current set of link weights is not an improvement over the previous set of link weights, the method 400 proceeds to block 460. If a determination is made that the current set of link weights is an improvement over a previous set of link weights, the method 400 proceeds to block 470. It is noted that block 450 is not performed in the first pass through method 400 since, at this point, the initial set of link weights has not yet been updated to provide an updated set of link weights.

At block 460, the most recent update to the set of link weights is reversed. In this way, the current set of link weights reverts to the previous set of link weights (i.e., the set of link weights used in the previous pass through the method 400). It is noted that block 460 is not performed in the first pass through method 400 since, at this point, the initial set of link weights has not yet been updated to provide an updated set of link weights.

At block 470, a determination is made as to whether a termination condition is detected. The termination condition is meant to terminate the execution of method 400 before the desired set of link weights (i.e., the set of link weights providing the requested traffic matrix or an actual traffic matrix that is relatively close to the requested traffic matrix) is determined. It will be appreciated that this provides tradeoffs between processing efficiency and degree of satisfaction of the goal of identifying the set of link weights that supports the requested traffic matrix or at least a traffic matrix that is relatively close to the requested traffic matrix. The termination condition may be a determination that the number of changes that have been made to the set of link weights satisfies a predetermined threshold, a determination that a threshold number of changes have been made to the set of link weights without any further improvement of the set of link weights in terms of identifying a set of link weights that produces the requested traffic matrix or without a threshold amount of improvement of the set of link weights in terms of identifying a set of link weights that produces the requested traffic matrix (e.g., where such improvement may be measured based on distance between the requested and routed traffic matrices), or the like, as well as various combinations thereof. If a termination condition is not detected, method 400 proceeds to block 480. If a termination condition is detected, method 400 proceeds to block 490.

At block 480, the current set of link weights is updated. The current set of link weights is updated in an attempt to improve the set of link weights in terms of identifying a set of link weights that produces the requested traffic matrix. From block 480, method 400 returns to block 420 so that the updated set of link weights may be evaluated for determining whether to select that updated set of link weights as the set of link weights to be used in the network.

The current set of link weights may be updated in various ways, both in each pass through this loop of the method 400 and across multiple passes through this loop of the method 400.

For example, in a given pass through this loop of method 400, one of the link weights may be increased or decreased by a predetermined amount, one link weight may be increased by a predetermined amount and one link weight may be decreased by a predetermined amount, two link weights may be increased by a predetermined amount and two link weights may be decreased by a predetermined amount, or the like, as well as various combinations thereof. It will be appreciated that, in a given pass through this loop of method 400, one or more link weights may be updated in various other ways.

For example, over multiple passes through this loop of method 400, each of the link weights may be alternatively increased and decreased one at a time in a particular order by a predetermined amount, each of the link weights may be alternatively increased and decreased one at a time in a particular order by twice the predetermined amount, each of the link weights may be alternatively increased and decreased one at a time in a particular order by three times the predetermined amount, and so forth. It will be appreciated that, over multiple passes through this loop of method 400, the set of link weights may be updated in various other ways.

In general, the updating of the current set of link weights may be performed in a manner that enables systematic evaluation of combinations of link weights for ruling out combinations of link weights that are not moving toward realization of the requested traffic matrix in the network and for retaining combinations of link weights that are moving toward realization of the requested traffic matrix in the network.

It will be appreciated that the current set of link weights may be updated in various other ways as method 400 is executed.

At block 490, the current set of link weights is output as the set of link weights to be used for the network (to support the requested traffic matrix or to provide a traffic matrix that is relatively close to the requested traffic matrix.

At block 499, method 400 ends.

It will be appreciated that, although primarily presented with respect to embodiments in which the latest set of link weights is output as the final set of link weights that is to be used for the network when a termination condition is detected, in at least some embodiments the latest set of link weights may not be output as final set of link weights to be used for the network (i.e., method 400 may proceed from block 470 to block 499 where method 400 ends), one or more additional evaluations may be performed to evaluate whether or not to use the latest set of link weights is output as final set of link weights to be used for the network (e.g., for determining whether, even though the latest set of link weights did not satisfy the distance evaluation, the latest set of link weights may nevertheless be used as the final set of link weights for the network).

It will be appreciated that the method 400 of FIG. 4 may be adapted to perform various other functions presented herein as being supported by a link weight control element (e.g., one or more of the LWCEs 130) for determining link weights for a set of links of a communication network for use in supporting shortest path routing within the communication network.

Various embodiments of the shortest path routing capability presented herein may be further understood by considering a more formal definition of and solution to the problem of determining links weights for communication links of a communication network. It will be appreciated that, while primarily presented herein within the context of a communication network utilizing a specific type of routing protocol (namely, an IGP such as OSPF or IS-IS), the more formal definition of and solution to the problem of determining links weights for communication links of a communication network may be adapted for use with various other types of routing protocols that may utilize shortest path routing.

First, consider a more formal definition of the network and traffic associated with the network. Here, assume that the network is represented as a directed capacitated graph G=(V,E) with n nodes V and m directed links E. The capacity of link e is denoted by c(e). Assume that a set of link weights w=(w(e₁),w(e₂), . . . w(eₘ)) is given. The traffic in the network is specified in terms of a n×n traffic matrix between each pair of nodes in the network. In order to keep the notation simple, each node pair is referred to as a commodity. The commodities of the traffic matrix are indexed by k. Here, s(k) and t(k) are used to denote the source and destination, respectively, corresponding to commodity k and d(k) is used to denote the amount of traffic between s(k) and t(k). For a given set of link weights w, traffic is routed between nodes u and v along the shortest path between u and v. This routing induces a flow on the links in the network. Let f(w,e) denote the flow on link e when link weights w are used in the network. It is noted that, in the case of an IGP for example, the objective of the IGP weight setting problem is to find the set of link weights w such that:

$${min}_{w} {max}_{e ∈ E} \frac{f ( w , e )}{c ( e )}$$

It will be appreciated that the problem of setting IGP weights to minimize congestion is an NP-complete problem.

Next, consider a more formal definition of the problem of determining the set of link weights for communication links of the network where the performance metric is link utilization of the links. Here, rather than using a surrogate function of utilization at each link, a more direct approach is used. Assume that the maximum utilization of any link in the network, λ, is known. Given a set of weights w=(w(e₁),w(e₂), . . . , w(eₘ)), let F(w,e) denote the set of commodities that flow on link e and let S(w,k) denote the set of links that are used by commodity k. S(w,k) represents the set of links in the shortest path between s(k) and t(k) using link weights w. Computing the set S(w,k) for a particular commodity k requires one shortest path computation. The goal is to select or determine a set of weights w such that:

$$\frac{{Σ}_{k ∈ F ( w , e )} d ( k )}{c ( e )} \leq λ ∀ e ∈ E$$

Instead of solving this problem directly, an optimization problem is formulated for a given set of weights w and an upper bound on the link utilization λ. The demand for commodity k, which is denoted as d(k), is given. For the given set of weights w (which in turn specifies the routing), if all the link utilizations are less than the upper bound on link utilization λ, then the set of link weights satisfies the demand d(k) such that the demand d(k) can be supported by the network. For the given set of weights (which in turn specifies the routing), if all the link utilizations are not less than the upper bound on link utilization λ, then an attempt is made to find the demand vector “closest” to the given demand vector d(k) that will result in all the link utilizations being less than the upper bound on link utilization λ. Let x(k) denote this demand vector that is “closest” to the given demand vector d(k). The closest distance between the demand vector x(k) and the demand vector d(k) may be defined as the Euclidean distance between the demand vector x(k) and the demand vector d(k), which may be represented as follows.

$$P ( w , λ ) = min {\sum }_{k} {[ x ( k ) - d ( k ) ]}^{2}$$

$${\sum }_{k ∈ F ( w , e )} x ( k ) \leq λ c ( e ) ∀ e ∈ E$$

$$x ( k ) \geq 0 ∀ k$$

It will be appreciated that this is a well-defined convex optimization problem and, further that various algorithms may be used to solve this problem. For example, a row-action algorithm, described further below, may be used to solve this problem. It will be appreciated that, although primarily described with respect to use of a row-action algorithm to solve the above-defined convex optimization problem, various other types of algorithms may be used to solve the above-defined convex optimization problem.

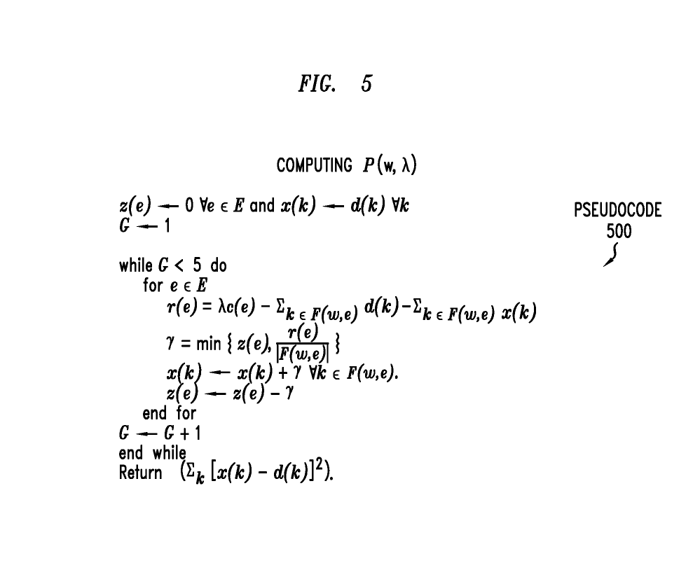

As indicated above, in at least some embodiments a row-action algorithm may be used to solve the above-defined convex optimization problem for determining the demand vector x(k) that is “closest” to the given demand vector d(k). The row action algorithm begins with some initial value of x(k) and then successively refines it to determine the value of x(k) that solves the above optimization problem. The successive refinement may be done one constraint at a time. The constraints, which may be arranged in arbitrary order, are visited cyclically. The algorithm may be executed for as many cycles as may be necessary or desired until some termination condition is satisfied. Here, x^{p}(k) is used to denote the value of x(k) at iteration p. Associated with link e is a parameter z(e) and the value of z(e) is updated whenever the capacity constraint for link e is visited. Here, z^{p}(e) is used to denote the value of z(e) at the end of iteration p. The row action algorithm works as follows: (1) if P(w,λ)=0, then the current set of weights w ensures that shortest path routing results in a set of flows such that none of the link utilizations is greater than the upper bound on link utilization λ and (2) if P(w,λ)>0, then the weights w are adjusted in order to decrease the value of P(w,λ). An example of pseudocode for such a row-action algorithm is depicted in FIG. 5 (denoted as pseudocode 500). As depicted in FIG. 5, the output of the pseudocode 500 is the distance between the demand vector x(k) and the demand vector d(k), which may be used to determine whether the demand vector d(k) can be satisfied by the network (P(w,λ)=0) or at least to identify a demand vector x(k) that is relatively close to the demand vector d(k) (P(w,λ)>0).

It is noted that, since there may be multiple sets of weights w that satisfy the condition that P(w,λ)=0, in at least some embodiments the overall object may be considered to be determining the smallest λ such that

$${min}_{w} P ( w , λ ) = 0.$$

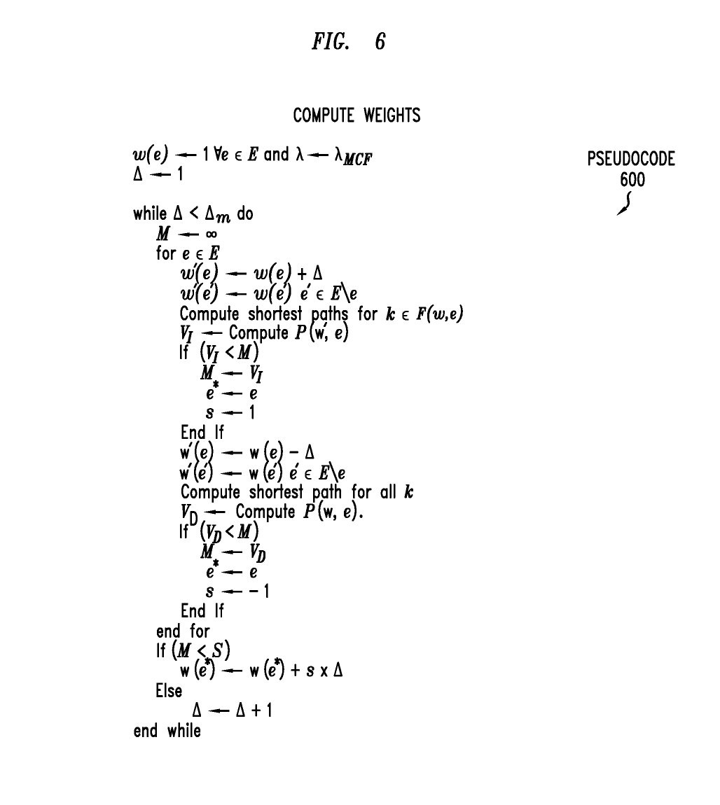

The algorithm to determine the best weight w for a given value of λ can be viewed as a coordinate steepest descent algorithm. The coordinate steepest descent algorithm may fix an increment/decrement parameter Δ that may be used for controlling changes to the value of weight w (for evaluating use of different weights w for the links). Let Iₑ denote an m-vector with zeros (“0”) in all of the indices with the exception of the index associated with link e, for which the index is a one (“1”). In each step of the algorithm, maxₑ P(w,λ)−P(w+ΔIₑ,λ) is computed and, if this value is positive and is attained at é, then the weight w is set as w←w+ΔI_{é}. The step is then repeated while decreasing the link weights w, i.e., computing P(w,λ)−P(w−ΔI_{e,λ}) and finding the link e that results in the biggest improvement in objective function. This process of increasing and decreasing the link weights by Δ is repeated until a condition is satisfied (e.g., no further improvement is possible, a threshold number of iterations is reached, or the like). Then, the value of Δ is increased (e.g., by one or by any other suitable value, which may depend on the scale of the values being used for the link weights or which may depend on other factors) and the process is repeated. This process of increasing the value of Δ is repeated until the value of Δ reaches some pre-specified upper bound or some other condition is satisfied. The value of Δ is reset (e.g., to “1” or to any other suitable value) based on a determination that there is an improvement in the objective function. It is noted that an update to the new solution may be made under certain conditions (e.g., based on a determination that the current solution is improved, based on a determination that the current solution is improved by a threshold amount (e.g., a value or a percentage), or the like). This process is repeated until the maximum number of iterations is reached or there is no improvement in objective function for a specified number of rounds. An example of pseudocode for such a coordinate steepest descent algorithm is depicted in FIG. 6 (denoted as pseudocode 600).

It is noted that the above-described approach may have certain advantages or potential advantages. The weight values are adjusted using global considerations. Additionally, the objective function that we are attempting to satisfy (namely, P(w,λ)=0) is known. The solution to P(w,λ) can be computed relatively quickly using an iterative scheme (e.g., Hildreth's algorithm or the like). It is possible to use a “hot start” approach in which the previous values of x(k) can be used as the initial solution in Hildreth's algorithm in order to further accelerate convergence. Additionally, it is possible to start with a few random initial weights and still find a relatively good set of weights for a given value of λ. This approach may obviate the need for cycling, since the objective function improves at each step. It is noted that, while the solution can get stuck at local minimum, the approach is amenable to re-optimizing with a new random initial weight. It is noted that the above-described approach may have various other advantages or potential advantages.

It will be appreciated that, although primarily presented herein within the context of using the above-described approach for solving the IGP weight setting problem, the above-described approach can be extended to variants of the IGP weight setting problem (e.g., the problem of determining weights for a network with link failures and routing using paths based on equal cost multi-path (ECMP) or other variants of the IGP weight setting problem).

In the presence of link failures, the associated constraints may be computed. Let Sₑ^{f} denote the set of commodities that use link e when there is failure f. Let Sₑ^{ϕ} denote the set of flows on link e when there are no failures in the system. It is noted that Sₑ^{ϕ} may be determined by running Dijkstra's algorithm from each node in the network.

In the presence of ECMP paths, weight setting may be performed as follows. In the case of ECMP, traffic from source to destination is split on equal cost paths. Let D(i, j) represent the shortest path distance between nodes i and j using link weight vector w. Consider a source-destination flow for commodity k that has to be routed from s(k) to t(k). Link e=(i,j) is on the shortest path for commodity k if D(s(k), i)+w(e)+D(j,t(k))=D(s(k),t(k)). At some node i, let NH (i,k) represent the set of links out of node i that are on the shortest path from i to k, that is: NH(i,k)={e=(i,j): D(s(k), i+w(e)+D(j,t(k))=D(s(k),t(k))}. A fraction

$$\frac{1}{\vert NH ( i , k ) \vert}$$

of the traffic for commodity k that reaches node i is sent along each of the links in NH(i,k). D(i,j) is used to represent the shortest path distance from i to j. Let α(e,k) represent the fraction of commodity k that is carried on link e. The value of α(e,k) is computed using:

$$\frac{F ( C )}{\vert NH ( c , k ) \vert}$$

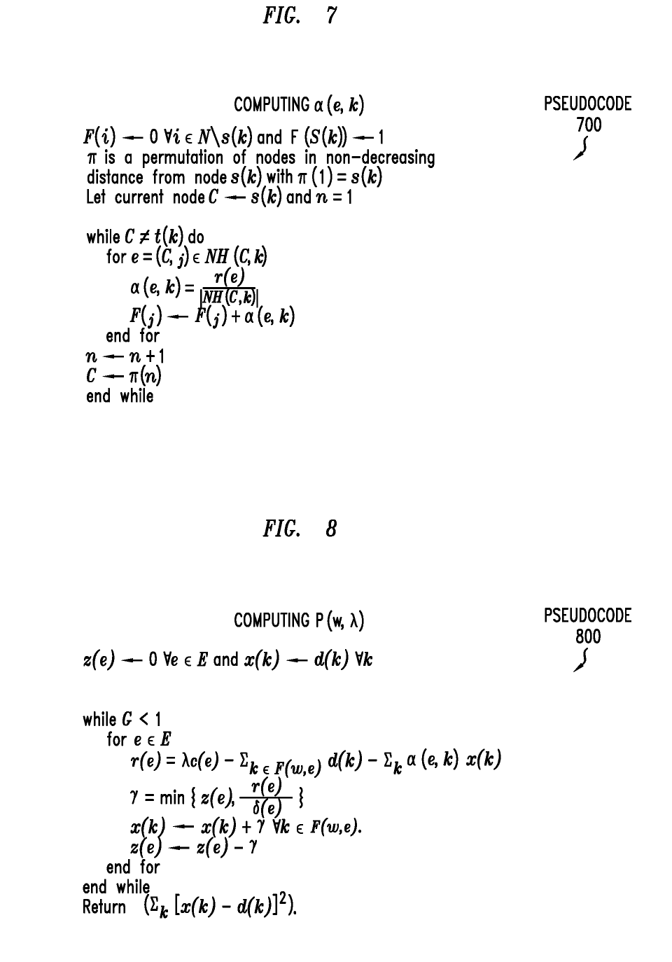

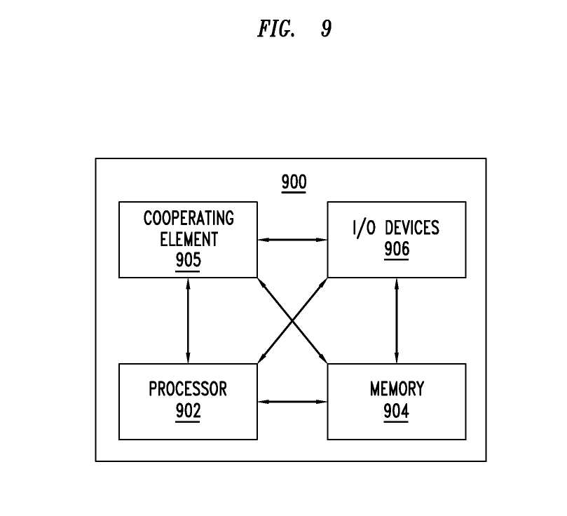

of. Let σ(e)=\sqrt{Σₖα²(e,k)}. An example of pseudocode for an algorithm for computing the fraction of commodity k that is carried on link e (again, denoted as α(e,k)) is depicted in FIG. 7 (denoted as pseudocode 700). An example of pseudocode for a row-action algorithm (similar to the row-action algorithm of FIG. 5) in the presence of ECMP is depicted in FIG. 8 (denoted as pseudocode 800). The coordinate steepest descent algorithm for the IGP weight setting problem (pseudocode 600 of FIG. 6) may be used as the coordinate steepest descent algorithm for the IGP weight setting problem variant in which ECMP paths are present (and, thus, is not repeated here).

It will be appreciated that various embodiments of the shortest path routing capability may provide various advantages or potential advantages. For example, various embodiment of the shortest path routing capability may be configured to minimize maximum link utilization in a network with a given traffic matrix. For example, various embodiment of the shortest path routing capability may be configured to reduce network congestion and improve network resource utilization through optimization of link weights used in IGP routing. For example, various embodiment of the shortest path routing capability may be configured to provide a more flexible approach for shortest path routing, including supporting of setting of different “lambda” values for different links so that different links can have a different target congestion levels. For example, various embodiment of the shortest path routing capability may be configured to operate, providing various advantages, in any networks running shortest path routing. For example, various embodiment of the shortest path routing capability may be configured to operate, providing various advantages, without relying on more complex traffic engineering technologies such as Multi-Protocol Label Switching (MPLS) and the like. It will be appreciated that various embodiments of the shortest path routing capability may provide various other advantages or potential advantages.

FIG. 9 depicts a high-level block diagram of a computer suitable for use in performing various functions described herein.

The computer 900 includes a processor 902 (e.g., a central processing unit (CPU), a processor having a set of processor cores, or the like) and a memory 904 (e.g., a random access memory (RAM), a read only memory (ROM), or the like). The processor 902 and the memory 904 are communicatively connected.

The computer 900 also may include a cooperating element 905. The cooperating element 905 may be a hardware device. The cooperating element 905 may be a process that can be loaded into the memory 904 and executed by the processor 902 to implement functions as discussed herein (in which case, for example, the cooperating element 905 (including associated data structures) can be stored on a non-transitory computer-readable storage medium, such as a storage device or other storage element (e.g., a magnetic drive, an optical drive, or the like)).

The computer 900 also may include one or more input/output devices 906. The input/output devices 906 may include one or more of a user input device (e.g., a keyboard, a keypad, a mouse, a microphone, a camera, or the like), a user output device (e.g., a display, a speaker, or the like), one or more network communication devices or elements (e.g., an input port, an output port, a receiver, a transmitter, a transceiver, or the like), one or more storage devices (e.g., a tape drive, a floppy drive, a hard disk drive, a compact disk drive, or the like), or the like, as well as various combinations thereof.

It will be appreciated that computer 900 of FIG. 9 may represent a general architecture and functionality suitable for implementing functional elements described herein, portions of functional elements described herein, or the like, as well as various combinations thereof. For example, computer 900 may provide a general architecture and functionality that is suitable for implementing one or more of an NE 112, the NCE 120, or a LWCE 130.

It will be appreciated that the functions depicted and described herein may be implemented in software (e.g., via implementation of software on one or more processors, for executing on a general purpose computer (e.g., via execution by one or more processors) so as to provide a special purpose computer, and the like) and/or may be implemented in hardware (e.g., using a general purpose computer, one or more application specific integrated circuits (ASIC), and/or any other hardware equivalents).

It will be appreciated that at least some of the functions discussed herein as software methods may be implemented within hardware, for example, as circuitry that cooperates with the processor to perform various functions. Portions of the functions/elements described herein may be implemented as a computer program product wherein computer instructions, when processed by a computer, adapt the operation of the computer such that the methods and/or techniques described herein are invoked or otherwise provided. Instructions for invoking the various methods may be stored in fixed or removable media (e.g., non-transitory computer-readable media), transmitted via a data stream in a broadcast or other signal bearing medium, and/or stored within a memory within a computing device operating according to the instructions.

It will be appreciated that the term “or” as used herein refers to a non-exclusive “or” unless otherwise indicated (e.g., use of “or else” or “or in the alternative”).

It will be appreciated that, although various embodiments which incorporate the teachings presented herein have been shown and described in detail herein, those skilled in the art can readily devise many other varied embodiments that still incorporate these teachings.

What is claimed is:

1. An apparatus, comprising:
a processor and a memory communicatively connected to the processor, the processor configured to:
receive a requested traffic matrix indicative of traffic to be routed through a network including a set of nodes and a set of links, a set of link weights associated with the respective links, and a performance metric;
determine, based on the requested traffic matrix and the set of link weights, a routed traffic matrix indicative of routing of the traffic of the requested traffic matrix in the network using the set of link weights;
determine, based on the performance metric, a distance between the requested traffic matrix and the routed traffic matrix; and
determine, based on the distance between the requested traffic matrix and the routed traffic matrix, whether to accept or reject the set of link weights for the network.

2. The apparatus of claim 1, wherein the performance metric comprises a maximum link utilization for the network.

3. The apparatus of claim 1, wherein the processor is configured to:
accept the set of link weights for the network based on a determination that the distance between the requested traffic matrix and the routed traffic matrix satisfies a threshold.

4. The apparatus of claim 1, wherein the processor is configured to:
reject the set of link weights for the network based on a determination that the distance between the requested traffic matrix and the routed traffic matrix fails to satisfy a threshold.

5. The apparatus of claim 4, wherein the processor is configured to:
modify the set of link weights to provide a modified set of link weights;
determine, based on requested traffic matrix and the modified set of link weights, a new routed traffic matrix indicative of routing of the traffic of the requested traffic matrix in the network using the modified set of link weights;
determine, based on the performance metric, a new distance between the requested traffic matrix and the new routed traffic matrix; and
determine, based on the new distance between the requested traffic matrix and the new routed traffic matrix, whether to accept or reject the modified set of link weights for the network.

6. The apparatus of claim 5, wherein, to modify the set of link weights to provide the modified set of link weights, the processor is configured to:
increase or decrease the link weight of one of the links by a predetermined amount.

7. The apparatus of claim 1, wherein the processor is configured to:
modify the performance metric, based on a determination to accept the set of link weights for the network, to provide thereby a modified performance metric.

8. The apparatus of claim 7, wherein the processor is configured to:
determine, based on the modified performance metric, a new distance between the requested traffic matrix and the routed traffic matrix; and
determine, based on the new distance between the requested traffic matrix and the routed traffic matrix, whether to accept or reject the set of link weights for the network.

9. The apparatus of claim 1, wherein the processor is configured to:
based on a determination to accept the set of link weights for the network, initiate configuration of the network to support the set of link weights for the network.

10. The apparatus of claim 9, wherein, to initiate configuration of the network to support the set of link weights for the network, the processor is configure to:
send, toward each of one or more of the nodes of the network, one or more messages configured to inform the respective node regarding one or more of the link weights in the set of link weights for the network.

11. A method, comprising:
receiving, by a processor, a requested traffic matrix indicative of traffic to be routed through a network including a set of nodes and a set of links, a set of link weights associated with the respective links, and a performance metric;
determining, by the processor based on the requested traffic matrix and the set of link weights, a routed traffic matrix indicative of routing of the traffic of the requested traffic matrix in the network using the set of link weights;
determining, by the processor based on the performance metric, a distance between the requested traffic matrix and the routed traffic matrix; and
determining, by the processor based on the distance between the requested traffic matrix and the routed traffic matrix, whether to accept or reject the set of link weights for the network.

12. The method of claim 11, wherein the performance metric comprises a maximum link utilization for the network.

13. The method of claim 11, further comprising:
accepting the set of link weights for the network based on a determination that the distance between the requested traffic matrix and the routed traffic matrix satisfies a threshold.

14. The method of claim 11, further comprising:
rejecting the set of link weights for the network based on a determination that the distance between the requested traffic matrix and the routed traffic matrix fails to satisfy a threshold.

15. The method of claim 14, further comprising:
modifying the set of link weights to provide a modified set of link weights;
determining, based on requested traffic matrix and the modified set of link weights, a new routed traffic matrix indicative of routing of the traffic of the requested traffic matrix in the network using the modified set of link weights;
determining, based on the performance metric, a new distance between the requested traffic matrix and the new routed traffic matrix; and
determining, based on the new distance between the requested traffic matrix and the new routed traffic matrix, whether to accept or reject the modified set of link weights for the network.

16. The method of claim 15, wherein modifying the set of link weights to provide the modified set of link weights comprises:
increasing or decreasing the link weight of one of the links by a predetermined amount.

17. The method of claim 11, further comprising:
modifying the performance metric, based on a determination to accept the set of link weights for the network, to provide thereby a modified performance metric.

18. The method of claim 17, further comprising:
determining, based on the modified performance metric, a new distance between the requested traffic matrix and the routed traffic matrix; and
determining, based on the new distance between the requested traffic matrix and the routed traffic matrix, whether to accept or reject the set of link weights for the network.

19. The method of claim 11, further comprising:
based on a determination to accept the set of link weights for the network, initiate configuration of the network to support the set of link weights for the network.

20. The method of claim 19, wherein initiating configuration of the network to support the set of link weights for the network comprises:
sending, toward each of one or more of the nodes of the network, one or more messages configured to inform the respective node regarding one or more of the link weights in the set of link weights for the network.

21. A non-transitory computer-readable storage medium storing instructions which, when executed by a computer, cause the computer to perform a method, the method comprising:
receiving a requested traffic matrix indicative of traffic to be routed through a network including a set of nodes and a set of links, a set of link weights associated with the respective links, and a performance metric;
determining, based on the requested traffic matrix and the set of link weights, a routed traffic matrix indicative of routing of the traffic of the requested traffic matrix in the network using the set of link weights;
determining, based on the performance metric, a distance between the requested traffic matrix and the routed traffic matrix; and
determining, based on the distance between the requested traffic matrix and the routed traffic matrix, whether to accept or reject the set of link weights for the network.
